(19) United States
(12) Patent Application Publication
(10) Pub. No.: US 2013/0164572 A1
(43) Pub. Date: Jun. 27, 2013

(54) BATTERY DEVICE WITH VERIFICATION FUNCTION, ANTI-THEFT METHOD AND PACKAGING METHOD THEREOF

(71) Applicants: Kuan Yuen LIAO, Kaohsiung CIty (TW); Sheng Wei Chen, Kaohsiung CIty (TW); Wen Jiun Liu, Kaohsiung CIty (TW)

(72) Inventors: Kuan Yuen LIAO, Kaohsiung CIty (TW); Sheng Wei Chen, Kaohsiung CIty (TW); Wen Jiun Liu, Kaohsiung CIty (TW)

(73) Assignee: Metal Industries Research & Development Centre, Kaohsiung City (TW)

(21) Appl. No.: 13/332,372

(22) Filed: Dec. 21, 2011

(51) Int. Cl. H01M 10/42

(52) U.S. Cl. 429/50; 429/61

(57) ABSTRACT

A battery device with a verification function, an anti-theft method and a packaging method thereof are disclosed. By detecting electrical characteristics of a battery, an enabling or disable signal is generated. When the enable signal is generated, a transmission unit is triggered for verification as well as obtaining a verification result. When the verification result fails, the self-discharge rate of the battery is increased. This mechanism helps improving the anti-theft function of the battery.

### BACKGROUND OF RELATED ART

1. Technical Field

The invention relates to a battery anti-theft device, anti-theft method, and the packaging method thereof. In particular, the invention relates to a battery device with a verification function, an anti-theft method and a packaging method thereof that can perform remote verification and, when the verification result fails, increase the self-discharge rate of the battery.

2. Related Art

In recent years, the popularity and prosperous development of secondary battery (also known as rechargeable battery) bring wide applications in such vehicles as hybrid cars, fuel battery cars, electric cars, etc. However, the convenience in battery installation/uninstallation results in a high theft rate. Therefore, how to enhance the anti-theft function for the batteries has become an urgent issue for all vendors.

Generally speaking, the anti-theft function is achieved by some special hardware. For example, one can use a lock to fix the battery in order to prevent unauthorized people to uninstall. However, this anti-theft ability depends on the sturdiness of the lock. In general, it is still possible to break such a lock by force. Some others propose to add a switch lock between the positive and negative poles inside the lead-acid battery so that it becomes conductive after being unlocked. However, this method is not applicable to other batteries, such as the lithium battery.

In view of this, some vendors burn the serial number and password into a controller and use the serial bus to transmit anti-theft information, thereby enabling the associated device to identify whether it is an authentic battery. The identification result is used to control the external switch of the battery, making the circuit on or off. As a result, the battery is not limited to special hardware but applicable to various battery production processes. However, the above-mentioned method is an anti-theft means using an external mechanism. A burglar can simply bypass the switch to steal the battery. Thus, it cannot effectively solve the problem.

In summary, the prior art always has the need for better anti-theft means for batteries. It is the objective of the invention to provide an improved technology.

### SUMMARY

In view of the foregoing, the invention discloses a battery device with a verification function, an anti-theft method and a packaging method thereof.

The disclosed battery device with the verification function includes: a battery unit, a transmission unit, a sensor unit, and a control unit. The battery unit stores and provides electrical power. The transmission unit sends a verification request to a verification end and receives a verification result from the verification end. The sensor unit is electrically connected to the battery unit for continuously detecting an electrical parameter of the battery unit and generating an enabling or disable signal according to the electrical parameter. The control unit is electrically connected with the sensor unit, the transmission unit and a discharge path in order to operate when an enable signal is generated or to shut off when a disable signal is generated. During the operation, the transmission unit is triggered to send the verification request and receive the verification result. When the verification result is success, setting the battery device into an idle or an energy saving mode such as the transmission unit is disabled, the control unit is turn off or etc. When the verification result fails, the discharge path is turned on to consume the electrical power in the battery unit.

The disclosed battery anti-theft method with a verification function applies to a battery device with a battery unit, a transmission unit, a sensor unit, and a control unit. The method includes the steps of: using the sensor unit to continuously detect an electrical parameter of the battery unit and generating an enabling or disable signal according to the electrical parameter; when an enable signal is generated, using the control unit to trigger the transmission unit for sending a verification request to a verification end and for receiving a verification result from the verification end; setting the battery device into an idle or an energy saving mode when the verification result is success, and turning off the control unit when a disable signal is generated; using the control unit to start a discharge path to consume the electrical power of the battery when the verification result fails and turning off the control unit when a disable signal is generated.

The disclosed packaging method for a battery device with a verification function applies to a battery device with a battery unit, a transmission unit, a sensor unit, and a control unit. The method includes the steps of: attaching a anti-theft element to a battery unit and packaging the transmission unit, the sensor unit, the control unit, a discharge path, and first and second electrodes of the battery unit, wherein the first electrode and the second electrode of the battery unit are partially exposed from the anti-theft element to form a first conductive point and a second conductive point, respectively.

The invention differs from the prior art in that the invention detects the electrical parameter of the battery unit to generate enabling or disable signals. When an enable signal is generated, the transmission unit is triggered for verification. When the obtained verification result fails, the self-discharge rate of the battery unit is increased.

Using the above-mentioned techniques, the invention achieves the goal of improving anti-theft of batteries.

### BRIEF DESCRIPTION OF THE DRAWINGS

The invention will become more fully understood from the detailed description given herein below illustration only, and thus is not limitative of the present invention, and wherein:

FIG. 1 is a system block diagram of the disclosed battery device with a verification function;

FIG. 2 is a flowchart of the disclosed anti-theft method for a battery with a verification function;

FIG. 3 is a flowchart of the disclosed packaging method for a battery with a verification function; and

FIG. 4 is a schematic view showing how the disclosed battery operates when it is stolen.

### DETAILED DESCRIPTION

The present invention will be apparent from the following detailed description, which proceeds with reference to the accompanying drawings, wherein the same references relate to the same elements.

Before describing the disclosed battery device with a verification function, the anti-theft method and the packaging method thereof, we first define terms used herein. The verification end referred herein is a device with functions of transmission and providing verification results, such as a personal digital assistant (PDA), a mobile phone, a vehicle computer, etc. In practice, the invention can transmit the verification request to and receive the verification result from the verification end in a wired or wireless method, such as the Ethernet or Bluetooth.

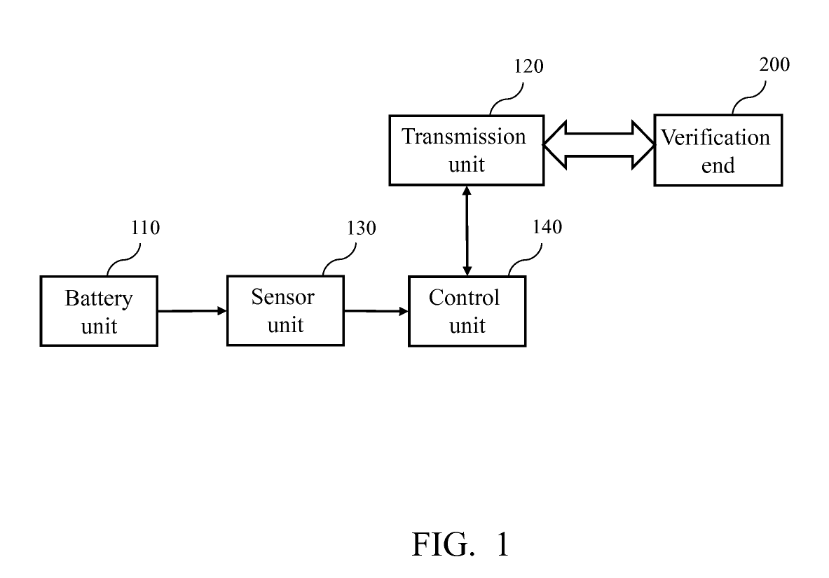

Please refer to FIG. 1 for the system block diagram of the disclosed battery device with a verification function. The battery device includes: a battery unit 110, a transmission unit 120, a sensor unit 130, and a control unit 140. The battery unit 110 stores and provides electrical power. The battery unit 110 is a secondary battery (also known as rechargeable battery) with a first electrode (e.g., anode) and a second electrode (e.g., cathode). Since this part belongs to the prior art, it is not further described herein.

The transmission unit 120 sends a verification request to the verification end 200 and receives a verification result from the verification end 200. In practice, the transmission unit 120 can send the verification request to the verification end 200 in a wired or wireless method. For example, suppose the transmission unit 120 adopts the wired transmission via a signal line. When the battery device is a vehicle battery and is stolen, the signal line is broken. Therefore, the transmission unit 120 cannot send the verification request to the verification end 200 disposed on the vehicle and cannot receive the verification result from the verification end 200 either. The control unit 140 determines that the verification result as failure. Suppose the transmission unit 120 adopts the wireless transmission via, for example, Bluetooth. When the battery device is stolen, the burglar does not have the verification end 200 disposed on the mobile device. Thus, the transmission unit 120 cannot obtain a response (e.g., the verification result) after sending the verification request. In this case, the control unit 140 also determines the verification result as failure.

The sensor unit 130 is electrically connected with the battery unit 110, and contains a sensor to continuously detect electrical parameter of the battery unit 110. The sensor can be a voltage sensor, temperature sensor, electrical current sensor, etc. When the sensor is a voltage sensor, the corresponding electrical parameter is the voltage value. When the sensor is a temperature sensor, the corresponding electrical parameter is the temperature value. When the sensor is an electrical current sensor, the corresponding electrical parameter is the current value. Afterwards, the sensor unit 130 generates an enable signal or a disable signal according to the electrical parameter. For example, the electrical parameter is compared with a predetermined condition. Suppose the predetermined condition is “I; >1 mA, Enable; <1 mA, Disable,” where I represents a current threshold. “>1 mA, Enable” and “<1 mA, Disable” represent the comparison conditions and the corresponding actions. That is, suppose the electrical parameter is the electrical current value. When the electrical current value is greater than 1 mA, an enable signal is generated. When the current value is smaller than 1 mA, a disable signal is generated. Likewise, suppose the predetermined condition is “R; >=20 ohm, Enable; <20 ohm, Disable,” where R represents a resistance threshold. “>=20 ohm, Enable” and “<20 ohm, Disable” represent the comparison conditions and the corresponding actions. That is, suppose the electrical parameter is the resistance value. When the resistance is greater than or equal to 20 ohm, an enable signal is generated to enable the control unit 140. Otherwise, a disable signal is generated to disable the control unit 140. It should be emphasized that even though the specification uses the above-mentioned examples to explain how the enable or disable signal is generated according to the electrical parameter, the invention is not limited by such cases. Any method that generates the enable or disable signal according to the electrical parameter should be included by the invention. Besides, in practice, the control of enabling and disabling the control unit 140 can be achieved using a metal-oxide semiconductor FET (MOSFET).

The control unit 140 electrically connects to the sensor unit 130, the transmission unit 120, and a discharge path (not shown), so as to operate when the sensor unit 130 generates an enable signal or shut down when the disable signal is generated. In other words, the operation of the control unit 140 is determined by the electrical parameter of the battery unit 110 detected by the sensor unit 130. During the operation of the control unit 140, the transmission unit 120 is triggered to send the verification request to and receive the verification result from the verification end 200. If the verification result is success, setting the battery device into the idle (e.g. the control unit 140 set into the idle mode) or the energy saving mode (e.g. the control unit 140 disables the transmission unit 120). The idle mode or the energy saving mode can be achieved by programming the control unit 140 (i.e. Programmable Logic Controller, PLC). In practice, the programming the control unit 140 further comprises other mode such as a normal operation, a full shutdown, an auto shutdown, an auto standby or etc. On the other hand, if the verification result is failure, the discharge path is initiated to consume the electrical power of the battery unit 110 rapidly. In practice, both ends of the discharge path electrically connect to the first electrode and the second electrode, respectively. The electrical connections between the discharge path and the first and second electrodes will be described with reference to accompanying drawings later.

It should be explained that in practice, the battery device further uses an anti-theft element (not shown) to package the transmission unit 120, the sensor unit 130, the control unit 140, the discharge path, the first electrode, and the second electrode, and attaches the anti-theft element to the battery unit 110. The first electrode and the second electrode are partially exposed from the anti-theft element to form a first conductive point and a second conductive point. The anti-theft element will be further explained with reference to the accompanying drawings later.

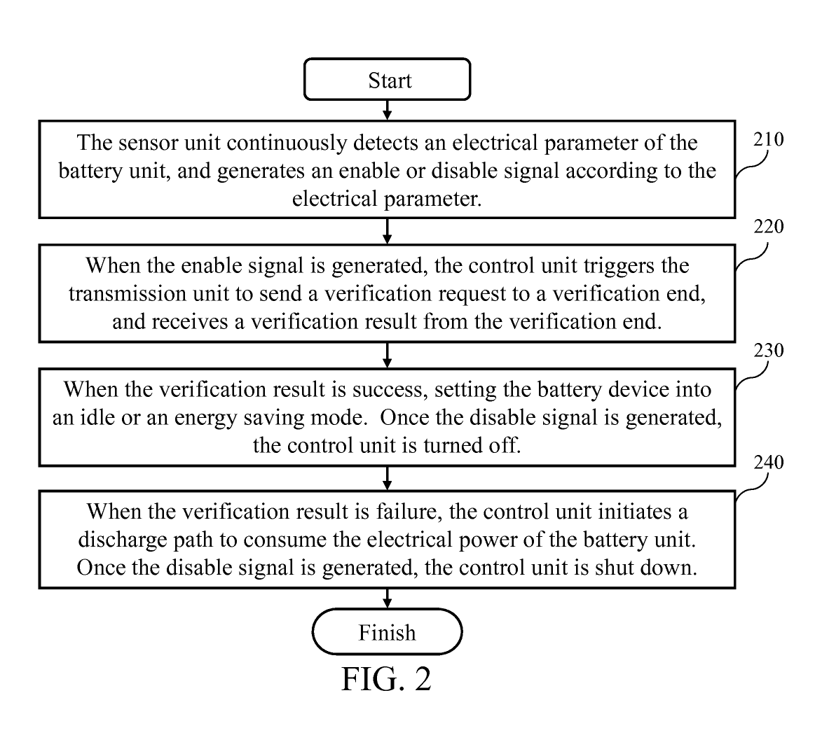

Please refer to FIG. 2, which is a flowchart of the disclosed battery anti-theft method with a verification function. This method is applicable to a battery device with a battery unit 110, a transmission unit 120, a sensor unit 130, and a control unit 140. The method includes the following steps. The sensor unit 130 continuously detects an electrical parameter of the battery unit 110 and generates an enable or disable signal according to the electrical parameter (step 210). When an enable signal is generated, the control unit 140 triggers the transmission unit 120 to send a verification request to a verification end 200 and to receive a verification result from the verification end 200 (step 220). When the verification result is success, setting the battery device into the idle or the energy saving mode and turning off (i.e. shuts down) the control unit 140 once the disable signal is generated (step 230). When the verification result is failure, the control unit 140 starts a discharge path to consume the electrical power of the battery unit 110. Once the disable signal is generated, the control unit 140 is shut down (step 240). Through the above-mentioned steps, the enable or disable signal can be generated according to the detected electrical property of the battery unit 110. When the enable signal is generated, the transmission unit 120 is triggered to perform the verification process and obtain the verification result. When the verification result is failure, the self-discharge rate of the battery unit 110 is increased.

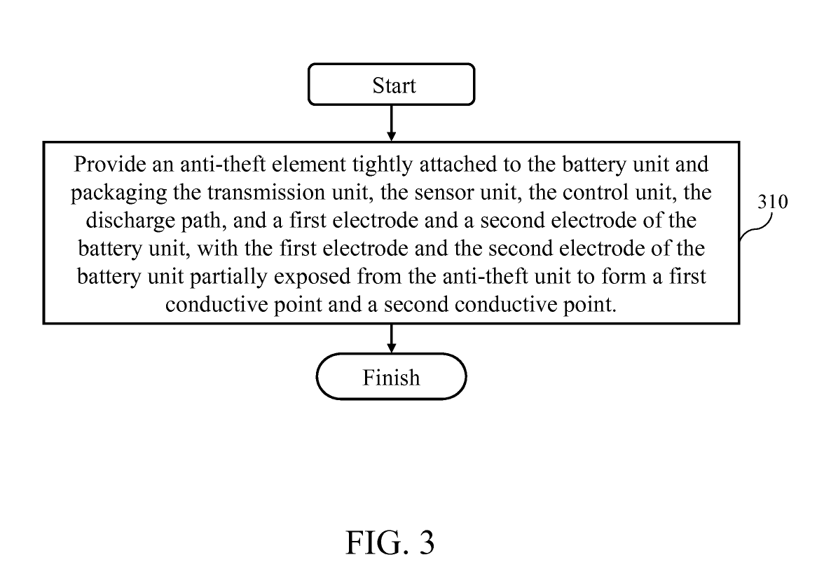

FIG. 3 is a flowchart of the disclosed packaging method for the battery device with a verification function. This method is applicable to a battery device with a battery unit 110, a transmission unit 120, a sensor unit 130, a control unit 140, and a discharge path. The method includes the following steps. An anti-theft element is provided to attach to the battery unit 110 and to package the transmission unit 120, the sensor unit 130, the control unit 140, the discharge path, and the first electrode and the second electrode of the battery unit 110. The first electrode and the second electrode of the battery unit 110 are partially exposed from the anti-theft to form a first conductive point and a second conductive point (step 310). In practice, the anti-theft element encloses the transmission unit 120, the sensor unit 130, the control unit 140, the discharge path, and the first electrode and the second electrode of the battery unit 110 with a plastic or ceramic material, and tightly attaches to the battery unit 110 so that it is difficult for the enclosed elements to leave the battery unit 110. If one removes the anti-theft element by force, the battery unit 110 is simply destroyed. For example, the first electrode and the second electrode break or the battery unit 110 has a leak.

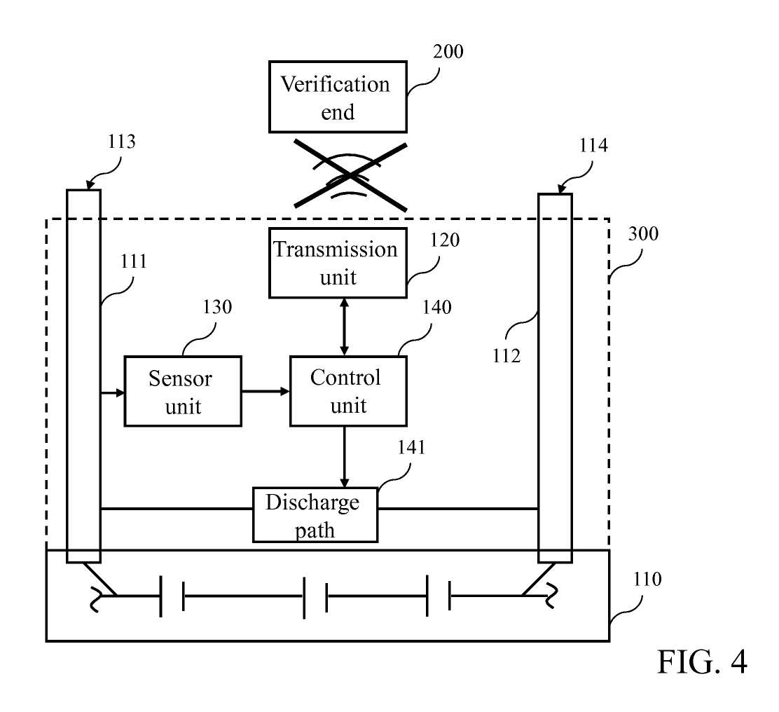

An embodiment is used to explain the invention with reference to FIG. 4. FIG. 4 is a schematic view showing how the disclosed battery device operates when it is stolen. As mentioned before, in practice, the disclosed battery device includes an anti-theft element 300 packaged with the transmission unit 120, the sensor unit 130, the control unit 140, the discharge path 141, the first electrode 111, and the second electrode 112. The packaging method can utilize a plastic or ceramic material to enclose the above-mentioned elements. The package is tightly attached to the battery unit 110. The first electrode 111 and the second electrode 112 are partially exposed from the anti-theft element 300 to form the first conductive point 113 and the second conductive point 114. The invention does not impose any restriction on the packaging method of the anti-theft element 300 and the method of attachment to the battery unit 110. Any packaging method that achieves difficulty in destruction and any method that renders the anti-theft element 300 difficult to depart from the battery unit 110 should be included by the invention. Once the anti-theft element 300 is removed, the removing process also destroys the entire or partial function of the battery unit 110. For example, during the removing process, the first electrode 111 and the second electrode 112 break, or the packaging of the battery unit 110 is broken to result in battery leakage. As a result, the battery unit 110 becomes useless even if the anti-theft element 300 is removed.

As described above, the anti-theft element 300 is difficult to be damaged and departed from the battery unit 110. Thus, when the disclosed battery device is stolen and used by the burglar, the sensor unit 130 can detect the change in the electrical parameter of the battery unit 110. The control unit 140 is then enabled according to this change so as to trigger the transmission unit 120 to perform verification with the verification end 200. However, since the battery device is stolen, the transmission unit 120 cannot complete the verification process. The control unit 140 determines the verification as failure and starts the discharge path 141 to speed up the consumption of the electrical power of the battery unit 110. Therefore, the self-discharge rate can be increased so that there is little power left for the device connected between the first conductive point 113 and the second conductive point 114.

It should be mentioned that when the discharge path 141 completes its initialization and the sensor unit 130 detects that the electrical parameter satisfies the predetermined condition (e.g., the predetermined condition is “<2 mA” meaning that the electrical parameter less than the electrical current of “2 mA” satisfies the predetermined condition and that the electrical parameter greater than the electrical current of “2 mA” dissatisfies the predetermined condition), the control unit 140 shuts down automatically until being enabled next time. On the other hand, when the electrical parameter does not satisfy the predetermined condition, the control unit 140 is continuously enabled. Suppose the verification result is success and the transmission unit 120 is disabled. If the sensor unit 130 detects that the electrical parameter satisfies the predetermined condition, the control unit 140 automatically shuts down until being enabled next time. Finally, in practice, to avoid the control unit 140 from switching between enable and disable repeatedly within a short time, a predetermined waiting time is employed after the sensor unit 130 detects that the electrical parameter satisfies the predetermined condition, thereby removing possible fluctuations in the electrical parameter. The predetermining waiting time can have different lengths according to different verification results. For example, when the verification result is success, then the predetermining waiting time is 30 seconds. When the verification result is failure, then the predetermined waiting time is 20 seconds. However, the invention is not limited by the above-mentioned examples.

In summary, the invention differs from the prior art in that the electrical property of the battery unit 110 is detected to generate an enable or disable signal. When the enable signal is generated, the control unit 140 triggers the transmission unit 120 to perform a verification process and to obtain the verification result. When the verification result is failure, the self-discharge rate of the battery unit 110 is increased. This technique solves problems existing in the prior art and achieves the goal of a better anti-theft function.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A battery device with a verification function, comprising:
a battery unit for storing and supplying electrical power;
a transmission unit for sending a verification request to a verification end and receiving a verification result from the verification end;
a sensor unit electrically connected to the battery unit for continuously detecting an electrical parameter of the battery unit and generating an enable or disable signal according to the electrical parameter; and
a control unit electrically connected to the sensor unit, the transmission unit and a discharge path for operating when the enable signal is generated and shutting down when the disable signal is generated;
wherein during the operation of the control unit, the transmission unit is triggered to send the verification request and to receive the verification result; when the verification result is success, the battery device set into an idle or an energy saving mode; and when the verification result is failure, the discharge path is initiated to consume the electrical power of the battery unit.

2. The battery device of claim 1, wherein the sensor unit generates the enable or disable signal according to whether the electrical parameter satisfies a predetermined condition.

3. The battery device of claim 1, wherein the sensor unit is a voltage sensor, electrical current sensor, temperature sensor or internal resistance sensor, and the detected voltage, electrical current, temperature, or internal resistance is taken as the electrical parameter of the battery unit.

4. The battery device of claim 1, wherein both ends of the discharge path electrically connect to a first electrode and a second electrode.

5. The battery device of claim 4 further comprising an anti-theft element tightly attached to the battery unit and packaging the transmission unit, the sensor unit, the control unit, the discharge path, the first electrode, and the second electrode, with the first electrode and the second electrode partially exposed from the anti-theft element to form a first conductive point and a second conductive point.

6. An anti-theft method for a battery with a verification function applied to a battery device with a battery unit, a transmission unit, a sensor unit and a control unit, comprising the steps of:
using the sensor unit to continuously detect an electrical parameter of the battery unit and generating an enable or disable signal according to the electrical parameter;
when the enable signal is generated, using the control unit to trigger the transmission unit to send a verification request to a verification end and to receive a verification result from the verification end;
setting the battery device into an idle or an energy saving mode when the verification result is success and turning off the control unit when the disable signal is generated; and
using the control unit to initiate a discharge path to consume the electrical power of the battery unit when the verification result is failure, and turning off the control unit when the disable signal is generated.

7. The anti-theft method of claim 6, wherein the step of generating an enable or disable signal according to the electrical parameter generates the enable or disable signal according to whether the electrical parameter satisfies a predetermined condition.

8. The anti-theft method of claim 6, wherein the step of setting the battery device into the idle or the energy saving mode when the verification result is success and after a first time parameter or when the verification result is failure and after a second time parameter.

9. The anti-theft method of claim 6, wherein both ends of the discharge path electrically connect to a first electrode and a second electrode.

10. A packaging method for a battery device with a verification function applied to a battery device with a battery unit, a transmission unit, a sensor unit, and a control unit and a discharge path, comprising the step of: providing an anti-theft element tightly attached to the battery unit and packaging the transmission unit, the sensor unit, the control unit, the discharge path, and a first electrode and a second electrode of the battery unit, with the first electrode and the second electrode of the battery unit exposed from the anti-theft element to form a first conductive point and a second conductive point.
